(19) United States
(12) Patent Application Publication
(10) Pub. No.: US 2008/0292226 A1
(43) Pub. Date: Nov. 27, 2008

(54) Linear motion guide apparatus

(75) Inventors: Scotte Chen, Taichung (TW); Tsung Jen Chen, Taichung (TW)

Correspondence Address: CHARLES E. BAXLEY, ESQUIRE, 90 JOHN STREET, SUITE 309, NEW YORK, NY, 10038, US

(73) Assignee: Hiwin Technologies Corp.

(21) Appl. No.: 11/805,148

(22) Filed: May 22, 2007

(51) Int. Cl. F16C 33/00

(52) U.S. Cl. 384/15

(57) ABSTRACT

A linear motion guide device includes a slider and two end caps attached to side portions of the slider, and two holding assemblies attached to two side legs of the slider and the end caps for forming four endless ball guiding channels and for smoothly receiving four chains of rolling members, the holding assemblies each include two L-shaped holding devices and a retaining device attached to the leg of the slider and the end caps, and the holding devices each include two detachable halves for allowing the holding devices to be easily and quickly molded and for allowing the holding devices to be easily disengaged from the mold devices.

### BACKGROUND OF THE INVENTION

1. Field of the Invention

The present invention relates to a linear motion guide apparatus, and more particularly to a linear motion guide apparatus including one or more holding devices and one or more retaining devices attachable to the slider for retaining the rolling or bearing device to the slider together with the end cap and for preventing the holding devices and the retaining devices and the rolling or bearing device from being removed or disengaged from the slider and the end cap.

2. Description of the Prior Art

Typical linear motion guide devices comprise a slider or slide block slidably attached onto a guide rail, and normally, a rolling or bearing device disposed between the slider and the guide rail for facilitating the sliding movement between the slider and the guide rail and for allowing the slider and the guide rail to be smoothly moved relative to each other.

For example, U.S. Pat. No. 5,947,605 to Shirai discloses one of the typical linear motion rolling guide devices comprising a number of ball retainer members for receiving a number of rolling or bearing members and for engaging into the ball guide passages and/or the ball return passages, and disposed between the movable block and the track rail for facilitating the sliding movement between the movable block and the track rail.

For attaching and retaining the rolling or bearing members to the movable block and the track rail, the rolling or bearing devices are required to provide one or more flexible connecting members for coupling a number of spacer members together and for engaging with and for retaining the rolling or bearing members between the spacer members of the ball retainer members.

However, the rolling or bearing members that are retained between the spacer members of the ball retainer members may not be easily engaged into the ball guide passages and/or the ball return passages of the movable block and the track rail after the rolling or bearing members have been assembled and engaged in and retained between the spacer members of the ball retainer members.

U.S. Pat. No. 6,908,228 to Dalessandro et al. discloses another typical linear motion rolling guide device or bearing segment comprising a number of arcuate interengageable self-contained rolling element retainer segments each including at least one rolling element track having a load bearing portion and a return portion.

However, it will be inconvenient to assemble and engage the rolling or bearing members between the rolling element retainer segments, and the rolling element retainer segments may not be easily attached to or engaged into the outer housing.

The present applicant has developed various kinds of linear motion rolling guide devices, one of the linear motion rolling guide devices has been issued as U.S. Pat. No. 7,044,641 to Scotte et al. which comprises a recirculating model to be engaged into the slide block for forming the ball guide passages and/or the ball return passages together with the end caps.

However, the recirculating model includes a U-shaped structure that may not be easily molded and may not be easily disengaged from the molds after the molding operation, and the other molding problems may also be generated or occurred.

The present invention has arisen to mitigate and/or obviate the afore-described disadvantages of the conventional linear motion guide apparatuses.

### SUMMARY OF THE INVENTION

The primary objective of the present invention is to provide a linear motion guide apparatus including one or more holding devices and one or more retaining devices attachable to the slider for retaining the rolling or bearing device to the slider together with the end cap and for preventing the holding devices and the retaining devices and the rolling or bearing device from being disengaged from the slider and the end cap.

The other objective of the present invention is to provide a linear motion guide apparatus including one or more holding devices and one or more retaining devices arranged to be easily molded or manufactured.

In accordance with one aspect of the invention, there is provided a linear motion guide apparatus comprising a guide rail including two side portions facing outwardly and including two inclined surfaces formed in each of the side portions, a slider slidably attached onto the guide rail and movable along the guide rail, the slider including a concave for forming two legs and for slidably receiving and engaging onto the guide rail, and including two inclined surfaces formed on each of the legs and facing toward the inclined surfaces of the guide rail respectively for forming two fore-and-aft raceway grooves between each of the legs of the slider and the guide rail, and including two conduits formed through each of the legs, a first end cap and a second end cap attached to end portions of the slider, the first and the second end caps each including a concave for forming two legs and for slidably receiving and engaging onto the guide rail, and each including a turnaround formed in each of the legs of the first and the second end caps, two holding assemblies attached to the legs of the slider and the first and the second end caps respectively, and each of the holding assemblies including two L-shaped holding devices and a retaining device attached to the respective leg of the slider and the respective legs of the first and the second end caps for forming two endless ball guiding channels, and the holding devices of the holding assemblies each including two detachable halves for allowing the holding devices to be easily manufactured, and four chains of rolling members engaged through the endless ball guiding channels of the holding assemblies and engaged between the slider and the guide rail for facilitating a sliding movement between the slider and the guide rail.

The halves of each of the holding devices are detachably secured together with pegs and holes for allowing the holding devices to be easily and quickly molded.

The holding devices each include a tubular member engaged into the conduit of the slider and having a bore formed in the tubular member for receiving the rolling members, and each include an end member provided at one end of the tubular member for forming the L-shaped holding device, and the holding devices each include a curved ball return pathway formed in each of the end members and communicating with the bore of the tubular member for forming the endless ball guiding channels and for smoothly receiving the rolling members.

The first holding device of the holding devices includes a curved ball guiding slot formed in the end member and communicating with the bore the tubular member of a second holding device of the holding devices for forming the endless ball guiding channels, and the second holding device includes a curved ball guiding slot formed in the end member of the second holding device and communicating with the bore the tubular member of the first holding device for forming a portion of the endless ball guiding channels.

The holding devices each include two curved fences for forming the curved ball guiding slots of the holding devices. The curved ball guiding slots of the holding devices are aligned with and communicating with the curved ball guiding slots of the end members for forming the endless ball guiding channels.

The holding devices each include a protrusion formed on the end member, and the retaining devices each include a beam having two end notches for receiving the protrusions of the end members and for anchoring the retaining devices to the holding devices.

The holding devices each include a pin hole formed in the protrusion, and the retaining devices each include two projection extended into the notches of the beams for engaging with the pin holes of the protrusions of the end members and for anchoring the beams of the retaining devices between the end members of the holding devices.

The first and the second end caps each include a cavity formed in each of the legs of the first and the second end caps, and the retaining devices each include two anchoring pins extended from each of two end portions of the beam and engaged with the cavities of the first and the second end caps and for anchoring the beams of the retaining devices between the first and the second end caps.

The beams of the retaining devices each include a substantially triangular structure having two inclined surfaces facing toward the inclined surfaces of the guide rail respectively, and a bulge formed between the inclined surfaces of the beams.

The slider includes a recess formed in each of the legs of the slider and located between the inclined surfaces of the slider, and the bulges of the beams are engaged into the recesses of the leg of the slider for anchoring and retaining the retaining devices and the holding devices between the end caps.

The beams of the retaining devices each include an outer portion having two catches extended from two end portions thereof for engaging with the rolling members and for retaining the rolling members in the ball guiding channels.

The beams of the retaining devices are made of synthetic materials, and each of the beams include a pole engaged into and through the beam for reinforcing the beam. The pole preferably includes a circular cross section.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a linear motion guide apparatus in accordance with the present invention;

FIG. 2 is a partial exploded view of the linear motion guide apparatus;

FIG. 3 is a cross sectional view of the linear motion guide apparatus taken along lines 3-3 of FIG. 1;

FIG. 4 is a partial exploded view of the linear motion guide apparatus;

FIG. 5 is another partial exploded view of the linear motion guide apparatus;

FIG. 6 is a cross sectional view of the linear motion guide apparatus taken along lines 6-6 of FIG. 4;

FIG. 7 is a partial perspective view of the linear motion guide apparatus;

FIG. 8 is a cross sectional view of the linear motion guide apparatus taken along lines 8-8 of FIG. 7;

FIG. 9 is a cross sectional view similar to FIG. 8, illustrating the other application or arrangement of the linear motion guide apparatus;

FIG. 10 is a cross sectional view similar to FIGS. 8 and 9, illustrating the further application or arrangement of the linear motion guide apparatus;

FIG. 11 is a cross sectional view similar to FIG. 8-10, illustrating the still further application or arrangement of the linear motion guide apparatus; and

FIG. 12 is a cross sectional view similar to FIGS. 8-11, illustrating the still further application or arrangement of the linear motion guide apparatus.

### DETAILED DESCRIPTION OF THE PREFERRED EMBODIMENT

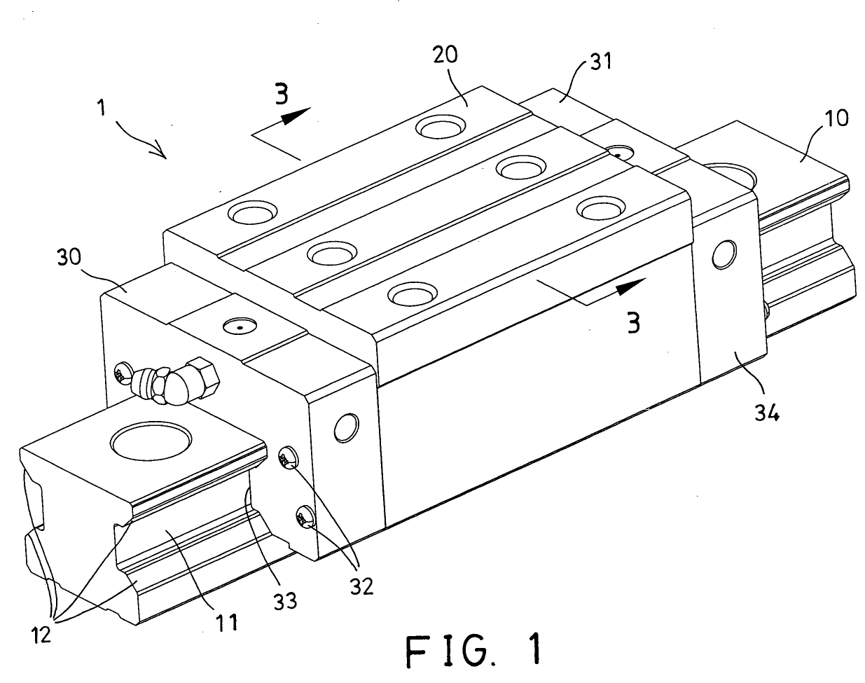

Referring to the drawings, and initially to FIGS. 1-3, a linear motion guide apparatus 1 in accordance with the present invention comprises a slide block or a slider 20 for slidably attaching onto a guide rail 10 and arranged to be moved along the guide rail, and normally, two end caps 30, 31 disposed on the two sides or end portions or outer portions of the slider 20 and attached or secured to the slider 20 with such as latches or fasteners 32 or the like. Two dust caps or wipers (not shown) may further be provided and disposed on the outer portions of the end caps 30, 31 and to be attached or secured onto the end caps 30, 31 with such as fasteners or latches (not shown) or the like. The guide rail 10 includes a longitudinal recess 11 formed in each of the two outer side portions thereof and facing outwardly, and includes two pairs or four inclined surfaces 12 formed and located on opposite sides of the longitudinal recesses 11 of the guide rail 10 respectively.

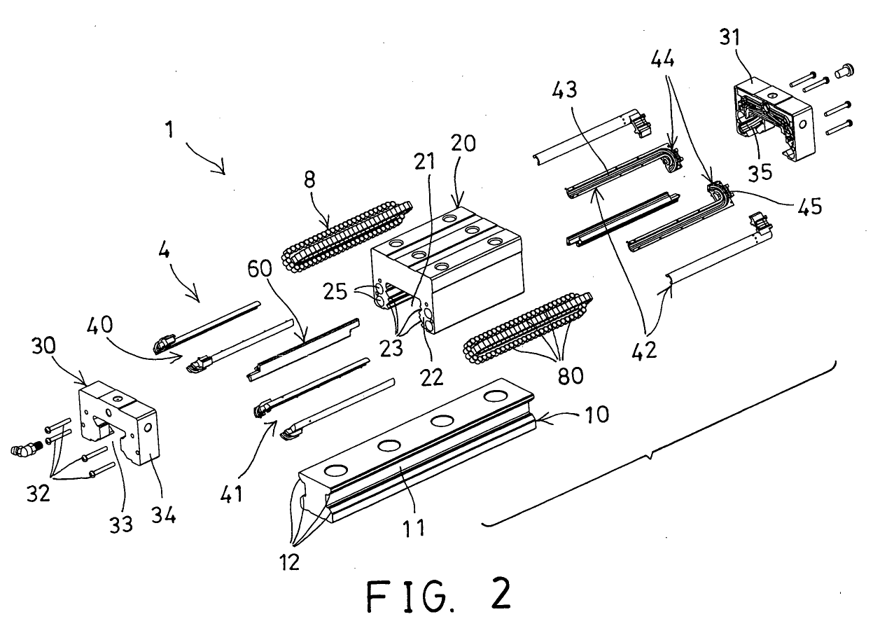

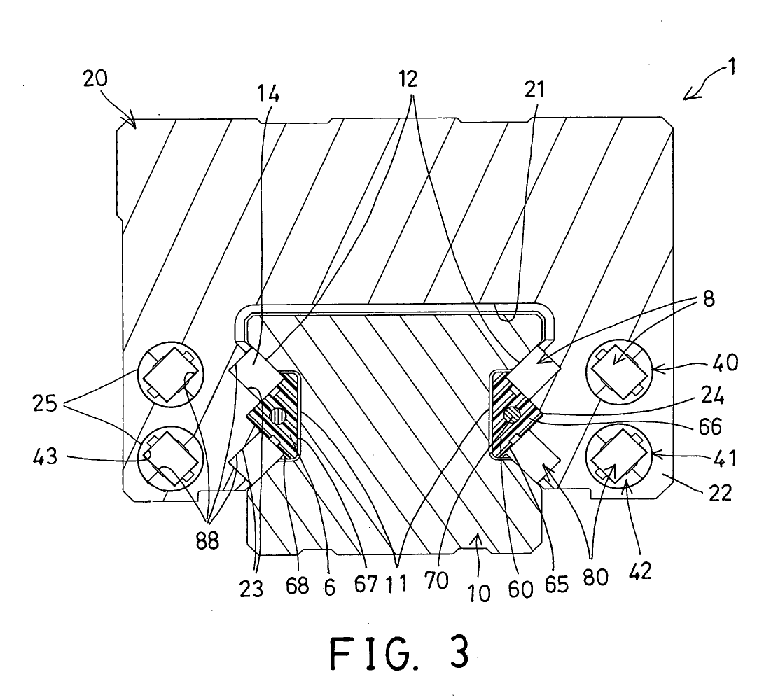

The slider 20 and the end caps 30, 31 each include a concave 21, 33 formed in the lower portion thereof for forming two legs 22, 34 (FIG. 2), or each include two legs 22, 34 for forming the concave 21, 33 and for slidably receiving or engaging onto the guide rail 10 and for allowing the slider 20 and the end caps 30, 31 to be guided or limited to slide along the guide rail 10. The slider 20 includes two inclined surfaces 23 formed and located on each of the legs 22 and facing toward the inclined surfaces 12 of the guide rail 10 respectively for forming one or more fore-and-aft raceway grooves 14 (FIG. 3) between the slider 20 and the guide rail 10, and the slider 20 further includes a V-shaped recess 24 formed in each of the legs 22 and located between the inclined surfaces 23, and one or more (such as two) conduits 25 longitudinally formed through each of the legs 22 and parallel to the concave 21 of the slider 20, and formed through the length of the legs 22.

As shown in FIGS. 2 and 3, a rolling or bearing device 8 includes a number of balls or rollers or rolling members 80 arranged in such as four chains for engaging through the fore-and-aft raceway grooves 14 and the conduits 25 of the slider 20 and the guide rail 10, and for being disposed and engaged between the slider 20 and the guide rail 10 and/or the end caps 30, 31 and for facilitating the sliding movement between the slider 20 and the guide rail 10 and for allowing the slider 20 and the guide rail 10 to be smoothly moved relative to each other. One or more (such as two) rolling member receiving or guiding or holding assemblies 4 are attached to the legs 22, 34 respectively and provided for forming or defining four endless ball guiding channels 88 and for receiving or engaging with the rolling or bearing device 8 and for stably retaining the rolling or bearing device 8 between the slider 20 and the guide rail 10.

The holding assemblies 4 each include two rolling member receiving or guiding or holding devices 40, 41 and a retaining device 60 attached to the respective legs 22, 34 and provided for forming or defining two endless ball guiding channels 88 and for receiving or engaging with the rolling or bearing device 8 and for stably retaining two chains of the rolling or bearing device 8 between the slider 20 and the guide rail 10. As shown in FIGS. 2-6, the holding devices 40 each include a longitudinal or tubular member 42 for engaging into the corresponding conduits 25 of the slider 20 and having a bore 43 formed in each of the tubular members 42 for forming a portion of endless ball guiding channels 88 and for receiving the rolling members 80 of the rolling or bearing device 8, and each include an end member 44 formed or provided at one end of each of the tubular members 42 for forming a substantially L-shaped structure.

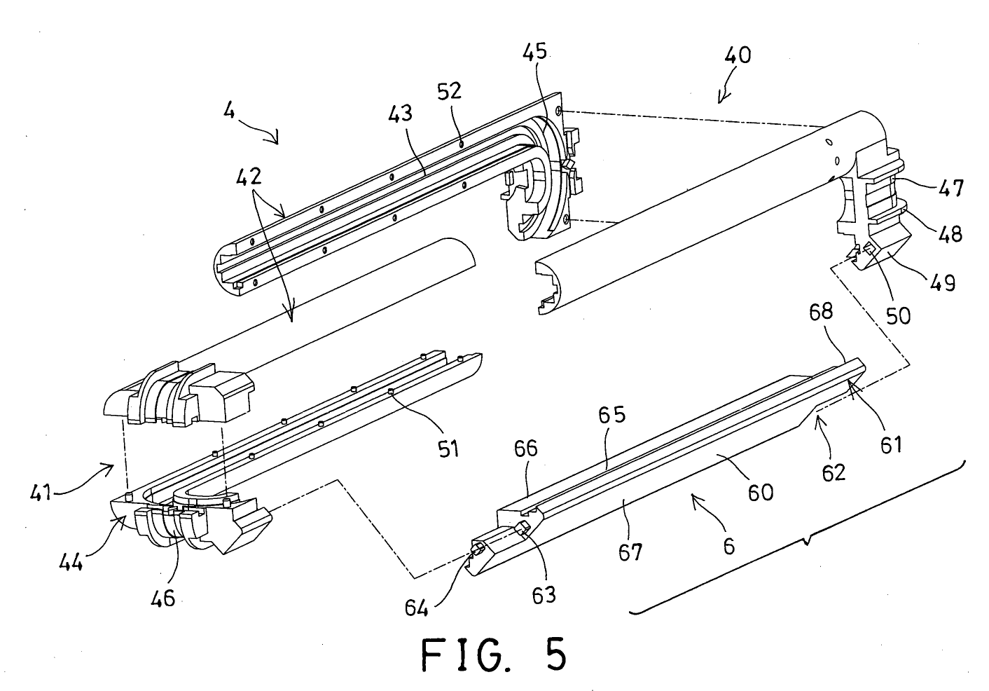

As shown in FIGS. 2 and 5, the holding devices 40, 41 each include a curved ball return pathway 45 formed in the end member 44 and communicating with the bore 43 of the tubular member 42 and also for forming another portion of the endless ball guiding channels 88 and for receiving the rolling members 80 of the rolling or bearing device 8. The curved ball return pathways 45 of the end members 44 are communicating with the fore-and-aft raceway grooves 14 that are formed between the slider 20 and the guide rail 10 (FIG. 3) respectively for forming a U-shaped portion of endless ball guiding channels 88 of the holding assemblies 4. The holding devices 40, 41 each further include a curved ball guiding slot 46, 47 formed in the end members 44 respectively and formed or defined between two curved fences 48 and communicating with the bores 43 of the tubular members 42 respectively for forming the endless ball guiding channels 88 of the holding assemblies 4.

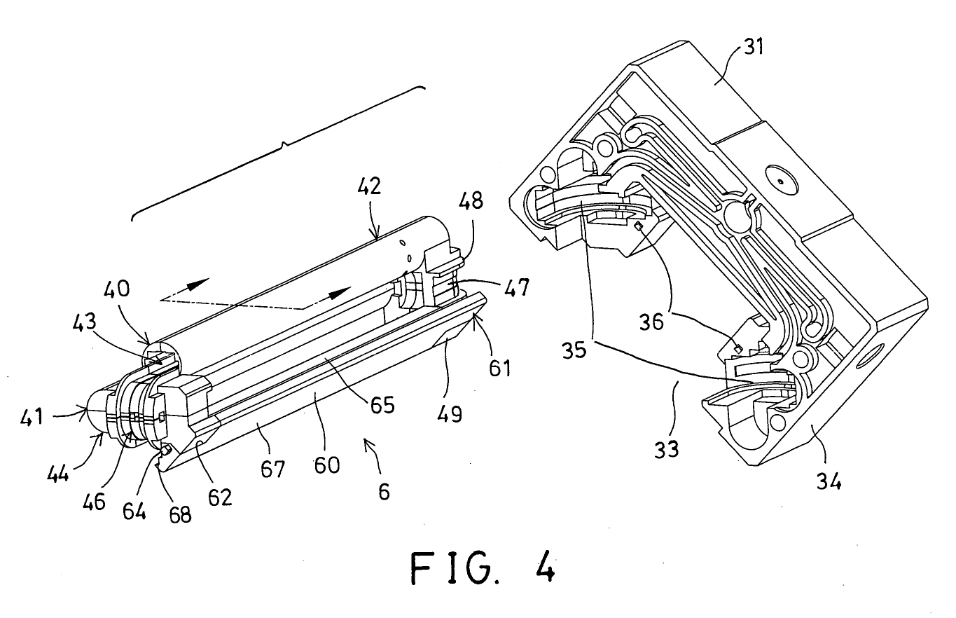

For example, the curved ball guiding slot 46 of the end member 44 of the holding device 41 is communicating with the bore 43 of the tubular member 42 of the other holding device 40, and is also communicating with the respective fore-and-aft raceway grooves 14 that are formed between the slider 20 and the guide rail 10 respectively for forming the endless ball guiding channels 88 of the holding assemblies 4. The end caps 30, 31 each include two ball deflecting or changing paths or turnarounds 35 formed therein (FIGS. 2, 4) and aligned with or communicating with the respective curved ball guiding slot 46, 47 of the end members 44 for enclosing the curved ball guiding slot 46, 47 of the end members 44 and for stably receiving and retaining the rolling members 80 of the rolling or bearing device 8 in the endless ball guiding channels 88 of the holding assemblies 4. For example, the turnarounds 35 of the end cap 31 are communicating with the curved ball guiding slots 47 of the holding devices 40, and the turnarounds 35 of the other end cap 30 are communicating with the curved ball guiding slots 46 of the other holding devices 41.

The holding devices 40, 41 each further include a protrusion 49 formed or provided or extended from one end or free end portion of the end member 44, and a pin hole 50 formed therein, such as formed in the protrusion 49 of the end member 44. The holding devices 40, 41 each may be formed or may include two halves detachably secured together with pegs 51 and holes 52 (FIG. 5) for allowing the end members 44 and the tubular members 42 of the holding devices 40, 41 to be easily and quickly molded or formed or manufactured. The end caps 30, 31 each further include one or more cavities 36 (FIG. 4) formed in each of the legs 34 for engaging with and for anchoring or positioning two retaining devices 6 to or between the end caps 30, 31. As shown in FIGS. 3-8, the retaining devices 6 each include two beams 60 each having two end portions 61 and each having a notch 62 formed in each of the end portions 61 for receiving the protrusions 49 of the end members 44 and for anchoring or positioning the retaining devices 6 to the holding devices 40, 41.

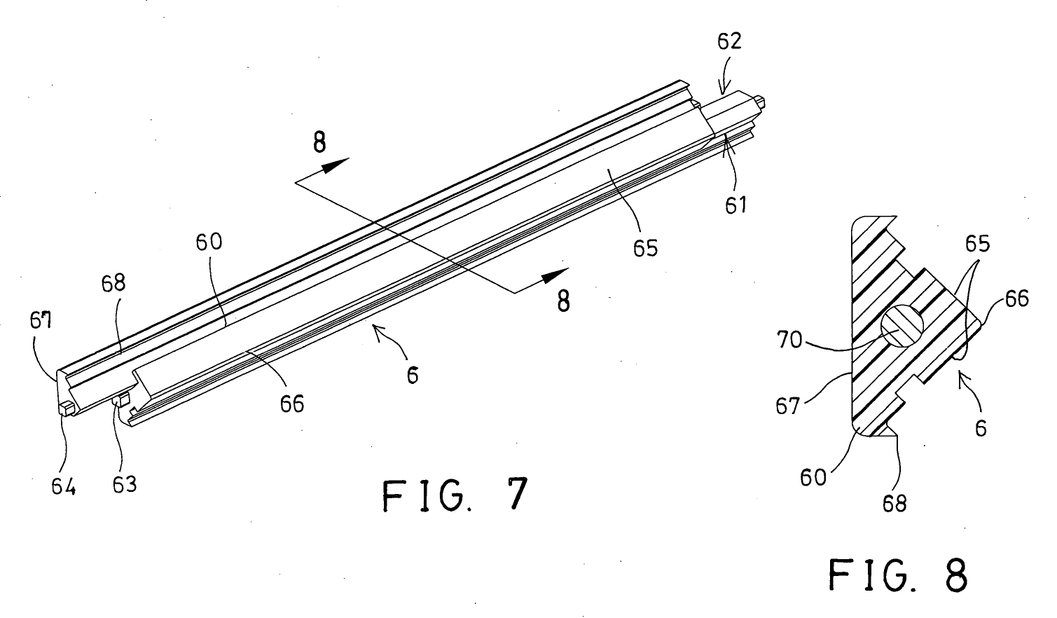

The beams 60 each include a projection 63 extended from each of the end portions 61 (FIGS. 5, 7) and extended into the respective notch 62 of the beams 60 for engaging with the pin holes 50 of the protrusions 49 of the end members 44 and for stably anchoring or positioning or securing the beams 60 of the retaining devices 6 between the end members 44 of the holding devices 40, 41 (FIG. 4). The beams 60 each further include an anchoring pin 64 extended from each of the end portions 61 (FIGS. 4, 5, 7) and offset from the notches 62 of the beams 60 for engaging with the cavities 36 of the end caps 30, 31 and for stably anchoring or positioning or securing the beams 60 of the retaining devices 6 between the end caps 30, 31, and thus for stably anchoring or positioning or securing the retaining devices 6 and the holding devices 40, 41 between the end caps 30, 31, and for allowing the retaining devices 6 and the holding devices 40, 41 of the respective holding assemblies 4 to be stably retained between the end caps 30, 31.

The beams 60 of the retaining devices 6 each include a substantially triangular structure having two inclined surfaces 65 (FIGS. 3-12) facing toward the inclined surfaces 12 of the guide rail 10 respectively for forming a portion of the fore-and-aft raceway grooves 14 that are formed between the slider 20 and the guide rail 10 and for stably retaining the two chains of the rolling or bearing device 8 in the endless ball guiding channels 88 of the holding assemblies 4 or between the slider 20 and the guide rail 10. The beams 60 of the retaining devices 6 each also include a bulge 66 formed and located between the inclined surfaces 65 and engaged into the recess 24 formed in the leg 22 of the slider 20 (FIG. 3) for further stably anchoring and retaining the retaining devices 6 and the holding devices 40, 41 between the end caps 30, 31.

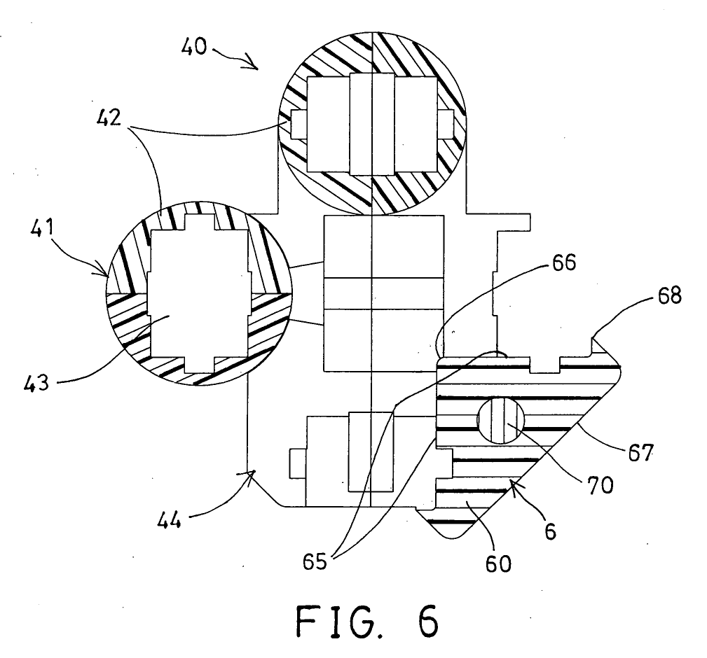

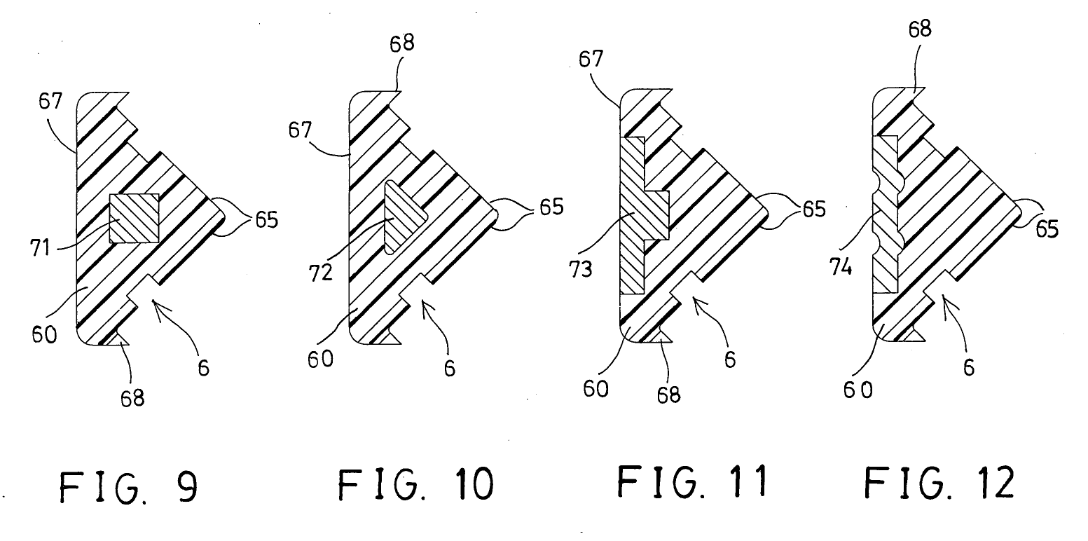

The beams 60 of the retaining devices 6 each further include an outer surface or portion 67 having two catches 68 extended from the end portions thereof for engaging with the rolling or bearing device 8 (FIG. 3) and for stably retaining and guiding the bearing device 8 to stably move through the ball guiding channels 88 of the holding assemblies 4 or between the slider 20 and the guide rail 10. As shown in FIGS. 6 and 8, the beams 60 of the retaining devices 6 are preferably made of plastic or rubber or synthetic materials and formed by such as molding processes, and each of the beams 60 includes a pole 70 engaged into and through the beam 60 and preferably engaged through the length of the beam 60 for reinforcing the beam 60 and for allowing the beams 60 of the retaining devices 6 to be easily and quickly molded or formed or manufactured. The pole 70 may include a circular cross section (FIGS. 6, 8), or a square pole 71 (FIG. 9), or a triangular pole 72 (FIG. 10), or other shaped poles 73, 74 (FIGS. 11-12) and engaged in the outer surface or portion 67 of the beam 60.

It is to be noted that the two rolling member receiving or guiding or holding assemblies 4 are attached to the legs 22, 34 of the slider 20 and the end caps 30, 31 respectively and provided for forming or defining four endless ball guiding channels 88 in the legs 22, 34 of the slider 20 and the end caps 30, 31 respectively and thus for stably and smoothly receiving or engaging with the rolling or bearing device 8 and for stably retaining the rolling or bearing device 8 between the slider 20 and the guide rail 10. The holding devices 40, 41 of the two holding assemblies 4 may first be attached or secured to the legs 22 of the slider 20 and retained between the end caps 30, 31 with the retaining devices 6 before the slider 20 is slidably engaged onto the guide rail 10. The L-shaped structure of the holding devices 40, 41 allows the holding devices 40, 41 to be easily and quickly molded or formed or manufactured and to be easily and quickly disengaged from the mold devices (not shown) after the molding operation.

Accordingly, the linear motion guide apparatus in accordance with the present invention includes one or more holding devices and one or more retaining devices attachable to the slider for retaining the rolling or bearing device to the slider together with the end cap and for preventing the holding devices and the retaining devices and the rolling or bearing device from being disengaged from the slider and the end cap.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A linear motion guide apparatus comprising:
a guide rail including two side portions facing outwardly and including two inclined surfaces formed in each of the side portions,
a slider slidably attached onto said guide rail and movable along said guide rail, said slider including a concave for forming two legs and for slidably receiving and engaging onto said guide rail, and including two inclined surfaces formed on each of said legs and facing toward said inclined surfaces of said guide rail respectively for forming two fore-and-aft raceway grooves between each of said legs of said slider and said guide rail, and including two conduits formed through each of said legs,
a first end cap and a second end cap attached to end portions of said slider, said first and said second end caps each including a concave for forming two legs and for slidably receiving and engaging onto said guide rail, and each including a turnaround formed in each of said legs of said first and said second end caps,
two holding assemblies attached to said legs of said slider and said first and said second end caps respectively, and each of said holding assemblies including two L-shaped holding devices and a retaining device attached to the respective leg of said slider and the respective legs of said first and said second end caps for forming two endless ball guiding channels, and said holding devices of said holding assemblies each including two detachable halves for allowing the holding devices to be easily manufactured, and
four chains of rolling members engaged through said endless ball guiding channels of said holding assemblies and engaged between said slider and said guide rail for facilitating a sliding movement between said slider and said guide rail.

2. The linear motion guide apparatus as claimed in claim 1, wherein said halves of each of said holding devices are secured together with pegs and holes.

3. The linear motion guide apparatus as claimed in claim 1, wherein said holding devices each include a tubular member engaged into said conduit of said slider and having a bore formed in said tubular member for receiving said rolling members, and each include an end member provided at one end of said tubular member for forming the L-shaped holding device, and said holding devices each include a curved ball return pathway formed in each of said end members and communicating with said bore of said tubular member for forming said endless ball guiding channels and for receiving said rolling members.

4. The linear motion guide apparatus as claimed in claim 3, wherein a first holding device of said holding devices includes a curved ball guiding slot formed in said end member and communicating with said bore said tubular member of a second holding device of said holding devices for forming the endless ball guiding channels, and said second holding device includes a curved ball guiding slot formed in said end member of said second holding device and communicating with said bore said tubular member of said first holding device for forming the endless ball guiding channels.

5. The linear motion guide apparatus as claimed in claim 4, wherein said holding devices each include two curved fences for forming said curved ball guiding slots of said holding devices.

6. The linear motion guide apparatus as claimed in claim 4, wherein said curved ball guiding slots of said holding devices are aligned with and communicating with said curved ball guiding slots of said end members for forming the endless ball guiding channels.

7. The linear motion guide apparatus as claimed in claim 3, wherein said holding devices each include a protrusion formed on said end member, and said retaining devices each include a beam having two end notches for receiving said protrusions of said end members and for anchoring said retaining devices to said holding devices.

8. The linear motion guide apparatus as claimed in claim 7, wherein said holding devices each include a pin hole formed in said protrusion, and said retaining devices each include two projection extended into said notches of said beams for engaging with said pin holes of said protrusions of said end members and for anchoring said beams of said retaining devices between said end members of said holding devices.

9. The linear motion guide apparatus as claimed in claim 1, wherein said first and said second end caps each include a cavity formed in each of said legs of said first and said second end caps, and said retaining devices each include two anchoring pins extended from each of two end portions of said beam and engaged with said cavities of said first and said second end caps and for anchoring said beams of said retaining devices between said first and said second end caps.

10. The linear motion guide apparatus as claimed in claim 1, wherein said beams of said retaining devices each include a substantially triangular structure having two inclined surfaces facing toward said inclined surfaces of said guide rail respectively, and a bulge formed between said inclined surfaces of said beams.

11. The linear motion guide apparatus as claimed in claim 10, wherein said slider includes a recess formed in each of said legs of said slider and located between said inclined surfaces of said slider, and said bulges of said beams are engaged into said recesses of said leg of said slider for anchoring and retaining said retaining devices and said holding devices between said end caps.

12. The linear motion guide apparatus as claimed in claim 1, wherein said beams of said retaining devices each include an outer portion having two catches extended from two end portions thereof for engaging with said rolling members and for retaining said rolling members in the ball guiding channels.

13. The linear motion guide apparatus as claimed in claim 1, wherein said beams of said retaining devices are made of synthetic materials, and each of said beams include a pole engaged into and through said beam for reinforcing said beam.

14. The linear motion guide apparatus as claimed in claim 13, wherein said pole includes a circular cross section.
